(19) United States
(12) Patent Application Publication
(10) Pub. No.: US 2025/0230386 A1
(43) Pub. Date: Jul. 17, 2025

(54) HEALTH CULTIVATION WINE AND PREPARATION METHOD THEREOF

(71) Applicant: Changde Jizhi Biological Technology Co., Ltd, Changde (CN)

(72) Inventor: Xinqiao HE, Changde (CN)

(21) Appl. No.: 18/413,097

(22) Filed: Jan. 16, 2024

(51) Int. Cl. C12G 3/055

(52) U.S. Cl. CPC C12G 3/055

(57) ABSTRACT

A health cultivation wine and a preparation method thereof are provided. The health cultivation wine, calculated by weight percentage, includes: 90-99% Baijiu, 0.05-1% turtle shell, 0.05-1% shark cartilage, 0.5-1% garlic, 0.05-1% Panax quinquefolius, 0.75-1% Lycium chinense, 0.25-1% jujube, 0.75-1% Angelica sinensis, and 0.75-1% Rehmannia glutinosa. The provided health cultivation wine is not only mild, but also refreshing, promotes blood circulation, improves sleep quality, especially has significant effect in prolonging life.

### TECHNICAL FIELD

The disclosure relates to the field of liquor-making technologies, and more particularly to a health cultivation wine and a preparation method thereof.

### BACKGROUND

Baijiu (also referred to as liquor, Chinese spirits, or Chinese Baijiu), as an indispensable food in people's daily life, is also developing in the direction of low degree, health care and functionalization along with consumers' demand for alcohol drinking. In order to meet the needs of consumers, the new concept of health factors is introduced into Baijiu. By adding active ingredients of traditional Chinese medicine with health care and health preservation effects to Baijiu, a new connotation of health care and health preservation can be given to Baijiu, which can realize pursuit of higher quality of life and demand for updating consumption patterns of consumers.

The combination of alcohol and medicine is a great progress in health preservation of alcohol drinking. Alcohol can extend medicinal effects from the surface to the top of head and regulate qi-flowing for activating blood, and can also make nourishing medicines supplement without stagnation. Alcohol helps to precipitate active ingredients of medicines. Alcohol is a good organic solvent, and most water-soluble substances and some substances that cannot be dissolved in water and need to be dissolved in non-polar solvents can be dissolved in alcohol. Alcohol also has good permeability, which can easily enter tissue cells of medicinal materials, play a role in dissolution, promote replacement and diffusion, and help improve the leaching speed and leaching effect. Therefore, the effective integration of effective ingredients of traditional Chinese medicine with wine is the result of the popularity of health cultivation wine in the new environment, and is also a deep excavation of existing Baijiu products, which will give customers a deep experience.

### SUMMARY

In order to solve technical problems in the related art, the disclosure provides a health cultivation wine (also referred to as a health-care liquor) and a preparation method thereof. The health cultivation wine is not only mild, but also can refresh, promote blood circulation, improve sleep quality, especially has significant effect in prolonging life.

Compared with the related art, technical solutions of the disclosure are as follows.

Specifically, in an aspect, a health cultivation wine is provided, including the following substances calculated by weight percentage:
90-99% Baijiu;
0.05-1% turtle shell;
0.05-1% shark cartilage;
0.5-1% garlic;
0.05-1% Panax quinquefolius;
0.75-1% Lycium chinense;
0.25-1% jujube;
0.75-1% Angelica sinensis; and
0.75-1% Rehmannia glutinosa;
where the Baijiu is sorghum liquor of 53-56 degrees.

In another aspect, a preparation method of the health cultivation, including the following steps.

Step (1), sorghum is soaked, the soaked sorghum is steamed, the steamed sorghum is re-steamed, then the re-steamed sorghum is removed, and the removed sorghum is cooled to 24-28 Celsius degree (° C.). 1% natural yeast powder calculated by weight percentage is sprinkled in the cooled sorghum to stir evenly to obtain a mixture, solid-state culture is performed on the mixture for 24 hours, and fermentation is performed on the cultured mixture in a fermentation tank at 28-38° C. to obtain a fermentation product. The fermentation product is taken out from the fermentation tank, and pyrogenic distillation is performed on the taken fermentation product to obtain the sorghum liquor. The sorghum liquor is stored in an earthen wine jar.

Step (2), the turtle shell is washed, the washed turtle shell is placed in a covered vessel, 10% water calculated by weight percentage is added into the covered vessel, and the covered vessel added with the washed turtle shell and the water is placed in a high-pressure cooker for 3-4 hours, and the turtle shell is completely softened into a paste to obtain a turtle shell paste. The turtle shell paste is dried and the dried turtle shell paste is crushed to obtain turtle shell powder.

Step (3), the garlic is peeled, the peeled garlic is sealed and kept away from light for 5-7 days at 3-5° C. until a bottom of the sealed garlic has a white beard in a range of 25-35 millimeters (mm) to obtain a target garlic. Then, the target garlic is taken out and the taken target garlic is soaked in mature vinegar for 55-65 days, and finally the soaked target garlic is taken out to dry and crush sequentially, to obtain garlic powder.

Step (4), the shark cartilage is dried, the dried shark cartilage is crushed to obtain shark cartilage powder, and then the shark cartilage powder is mixed with the turtle shell powder obtained in the step (2) in proportion to obtain a first mixed intermediate, and the first mixed intermediate is placed in an oven to bake to obtain mixed powder.

Step (5), the garlic powder obtained in the step (3) is added into the mixed powder obtained in the step (4) in proportion to obtain a second mixed intermediate, the second mixed intermediate is placed in a tank of a high-speed disperser and then stirred with the sorghum liquor, to obtain a wine mixture.

Step (6), the Panax quinquefolius, Lycium chinense, jujube, Angelica sinensis, and Rehmannia glutinosa in proportion are mixed to obtain a mixed traditional Chinese medicine.

Step (7), water is added into the mixed traditional Chinese medicine obtained in the step (6) to submerge a surface of the mixed traditional Chinese medicine for 1 centimeter (cm) to 2 cm, with a ratio of solid to liquid of 1:10, and then the mixed traditional Chinese medicine is soaked in the water for 1 hour to obtain a soaked mixture. Ultrasonic extraction is performed on the soaked mixture under an ultrasonic frequency of 20 kilohertz (kHz) at a temperature in a range of 45° C.-50° C. to obtain an extracted product, the extracted product is filtered to obtain medicine liquid, and the medicine liquid is extracted with water for three times continuously to obtain filtrates. The filtrates are mixed, concentrated the mixed filtrates in vacuum to be a thick paste, and stored the thick paste for later use.

Step (8), the wine mixture obtained in the step (5) and the thick paste obtained the in the step (7) are poured into an earthen wine jar for sealing to a mixed product, the mixed product is stored at 10-15° C. for 170-190 days, and then the stored product is filled to produce the health cultivation wine.

In an embodiment, fermentation time of the fermentation in the step (1) is in a range of 10-15 days.

In an embodiment, a temperature of the fermentation in the step (1) is in a range of 28-38° C.

In an embodiment, soaking days of the soaking in the step (3) are in a range of 55-65 days.

In an embodiment, a baking temperature of the oven in the step (4) is in a range of 55-65° C.

In an embodiment, time of the ultrasonic extraction in the step (7) is in a range of 20-30 minutes (min).

In an embodiment, time of the stirring in the step (5) is in a range of 55-65 min.

Compared with the related art, the disclosure has the following beneficial effects.

(1) The scientific compatibility and effective extraction are carried out on the traditional Chinese medicine raw materials according to the disclosure. The health cultivation wine provided by the disclosure has the effects of invigorating qi and blood circulation, beautifying and nourishing the skin, regulating the spleen and stomach, can improve human immunity after long-term administration, and has a good taste, meeting people's demand on the development of drinking in the direction of low-grade, health care, and functionalization.

(2) The health cultivation wine of the disclosure can not only easily enter the tissue cells of medicinal materials, play the role of dissolution, promote the replacement and diffusion, and is conducive to improving the leaching speed and leaching effect. Moreover, the health cultivation wine also has the functions of dredging meridians, promoting qi and blood circulation, eliminating dampness and resolving masses, warming yang and dispelling cold, soothing the liver and relieving depression, and promoting emotion and sense. Because the health cultivation wine is the essence of grain sorghum brewing, it can also tonify the intestines and stomach.

### DETAILED DESCRIPTION OF EMBODIMENTS

In order to enable those skilled in the art to understand technical solutions of the disclosure better, the following is a clear and complete description of the technical solutions in embodiments of the disclosure. Apparently, the described embodiments are only some of the embodiments of the disclosure, not all of the embodiments. Based on the embodiments of the disclosure, all other embodiments obtained by those skilled in the art without creative work should fall within the scope of the disclosure.

### Embodiment 1

Specifically, a health cultivation wine (also referred to as a health-care liquor) is provided. Baijiu is sorghum liquor of 53 degrees. Raw materials include 2000 catty (i.e., 1000 kilograms abbreviated as kg) sorghum liquor, 1 catty (i.e., 0.5 kg) turtle shell, 1 catty shark cartilage, 10 (i.e., 5 kg) catty garlic, 1 catty Panax quinquefolius (also referred to as American ginseng), 15 (i.e., 7.5 kg) catty Lycium chinense, 5 (i.e., 2.5 kg) catty jujube, 15 catty Angelica sinensis, and 15 catty Rehmannia glutinosa.

The health cultivation wine is prepared by the following methods.

Step (1), sorghum is soaked, the soaked sorghum is steamed, the steamed sorghum is re-steamed, then the re-steamed sorghum is removed, and the removed sorghum is cooled to 24 Celsius degree (° C.). 1% natural yeast powder calculated by weight percentage is sprinkled in the cooled sorghum to stir evenly to obtain a mixture, solid-state culture is performed on the mixture for 24 hours, and fermentation is performed on the cultured mixture in a fermentation tank at 28° C. for 15 days to obtain a fermentation product. The fermentation product is taken out from the fermentation tank, and pyrogenic distillation is performed on the taken fermentation product to obtain the sorghum liquor. The sorghum liquor is stored in an earthen wine jar.

Step (2), the turtle shell is washed, the washed turtle shell is placed in a covered vessel, 10% water calculated by weight percentage is added into the covered vessel, and the covered vessel added with the washed turtle shell and the water is placed in a high-pressure cooker for 3 hours, and the turtle shell is completely softened into a paste to obtain a turtle shell paste. The turtle shell paste is dried and the dried turtle shell paste is crushed to obtain turtle shell powder.

Step (3), the garlic is peeled, the peeled garlic is sealed and kept away from light for 5 days at 5° C. until a bottom of the sealed garlic has a white beard of 25 millimeters (mm) to obtain a target garlic. Then, the target garlic is taken out and the taken target garlic is soaked in mature vinegar for 55 days, and finally the soaked target garlic is taken out to dry and crush sequentially, to obtain garlic powder.

Step (4), the shark cartilage is dried, the dried shark cartilage is crushed to obtain shark cartilage powder, and then the shark cartilage powder is mixed with the turtle shell powder obtained in the step (2) in proportion to obtain a first mixed intermediate, and the first mixed intermediate is placed in an oven to bake the first mixed intermediate at a bake temperature of 55° C. to obtain mixed powder.

Step (5), the garlic powder obtained in the step (3) is added into the mixed powder obtained in the step (4) in proportion to obtain a second mixed intermediate, the second mixed intermediate is placed in a tank of a high-speed disperser and then stirred with the sorghum liquor for 55 minutes (min), to obtain a wine mixture.

Step (6), the Panax quinquefolius, Lycium chinense, jujube, Angelica sinensis, and Rehmannia glutinosa in proportion are mixed to obtain a mixed traditional Chinese medicine.

Step (7), water is added into the mixed traditional Chinese medicine obtained in the step (6) to submerge a surface of the mixed traditional Chinese medicine for 1 centimeter (cm), with a ratio of solid to liquid of 1:10, and then the mixed traditional Chinese medicine is soaked in the water for 1 hour to obtain a soaked mixture. Ultrasonic extraction is performed on the soaked mixture under an ultrasonic frequency of 20 kilohertz (kHz) at a temperature of 45° C. for 20 min to obtain an extracted product, the extracted product is filtered to obtain medicine liquid, and the medicine liquid is extracted with water for three times continuously to obtain filtrates.

The filtrates are mixed, concentrated the mixed filtrates in vacuum to be a thick paste, and stored the thick paste for later use.

Step (8), the wine mixture obtained in the step (5) and the thick paste obtained the in the step (7) are poured into an carthen wine jar for sealing to a mixed product, the mixed product is stored at 10° C. for 170 days, and then the stored product is filled to produce the health cultivation wine.

### Embodiment 2

Specifically, a health cultivation wine is provided. Baijiu is sorghum liquor of 53 degrees. Raw materials include 2000 catty sorghum liquor, 20 (i.e., 10 kg) catty turtle shell, 20 catty shark cartilage, 20 catty garlic, 20 catty Panax quinquefolius, 20 catty Lycium chinense, 20 catty jujube, 20 catty Angelica sinensis, 20 catty Rehmannia glutinosa.

The health cultivation wine is prepared by the following methods.

Step (1), sorghum is soaked, the soaked sorghum is steamed, the steamed sorghum is re-steamed, then the re-steamed sorghum is removed, and the removed sorghum is cooled to 28° C. 1% natural yeast powder calculated by weight percentage is sprinkled in the cooled sorghum to stir evenly to obtain a mixture, solid-state culture is performed on the mixture for 24 hours, and fermentation is performed on the cultured mixture in a fermentation tank at 38° C. for 10 days to obtain a fermentation product. The fermentation product is taken out from the fermentation tank, and pyrogenic distillation is performed on the taken fermentation product to obtain the sorghum liquor. The sorghum liquor is stored in an earthen wine jar.

Step (2), the turtle shell is washed, the washed turtle shell is placed in a covered vessel, 10% water calculated by weight percentage is added into the covered vessel, and the covered vessel added with the washed turtle shell and the water is placed in a high-pressure cooker for 4 hours, and the turtle shell is completely softened into a paste to obtain a turtle shell paste. The turtle shell paste is dried and the dried turtle shell paste is crushed to obtain turtle shell powder.

Step (3), the garlic is peeled, the peeled garlic is sealed and kept away from light for 7 days at 3° C. until a bottom of the sealed garlic has a white beard of 35 mm to obtain a target garlic. Then, the target garlic is taken out and the taken target garlic is soaked in mature vinegar for 65 days, and finally the soaked target garlic is taken out to dry and crush sequentially, to obtain garlic powder.

Step (4), the shark cartilage is dried, the dried shark cartilage is crushed to obtain shark cartilage powder, and then the shark cartilage powder is mixed with the turtle shell powder obtained in the step (2) in proportion to obtain a first mixed intermediate, and the first mixed intermediate is placed in an oven to bake the first mixed intermediate at a bake temperature of 65° C. to obtain mixed powder.

Step (5), the garlic powder obtained in the step (3) is added into the mixed powder obtained in the step (4) in proportion to obtain a second mixed intermediate, the second mixed intermediate is placed in a tank of a high-speed disperser and then stirred with the sorghum liquor for 65 min, to obtain a wine mixture.

Step (6), the Panax quinquefolius, Lycium chinense, jujube, Angelica sinensis, and Rehmannia glutinosa in proportion are mixed to obtain a mixed traditional Chinese medicine.

Step (7), water is added into the mixed traditional Chinese medicine obtained in the step (6) to submerge a surface of the mixed traditional Chinese medicine for 2 cm, with a ratio of solid to liquid of 1:10, and then the mixed traditional Chinese medicine is soaked in the water for 1 hour to obtain a soaked mixture. Ultrasonic extraction is performed on the soaked mixture under an ultrasonic frequency of 20 kHz at a temperature of 50° C. for 30 min to obtain an extracted product, the extracted product is filtered to obtain medicine liquid, and the medicine liquid is extracted with water for three times continuously to obtain filtrates. The filtrates are mixed, concentrated the mixed filtrates in vacuum to be a thick paste, and stored the thick paste for later use.

Step (8), the wine mixture obtained in the step (5) and the thick paste obtained the in the step (7) are poured into an earthen wine jar for sealing to a mixed product, the mixed product is stored at 10° C. for 190 days, and then the stored product is filled to produce the health cultivation wine.

Performance test of health cultivation wine

TABLE 1
Comparison of physical and chemical indexes between health cultivation
wine and Baijiu without Chinese medicinal materials (blank)

| | | Total acid | Amino | | Non | |
|---|---|---|---|---|---|---|
| | Alcohol | (calculated as | acid | Total sugar | sugar | Total |
| | content | lactic acid, | nitrogen | (calculated as | solids | flavonoids |
| Project | (%, vol) | g/L) | (g/L) | glucose, g/L) | (g/L) | (mg/100 mL) |
| Embodiment 1 | 15 | ≤5.5 | 0.6 | 38.54 | 40.03 | 186.23 |
| Embodiment 2 | 15 | ≤5.5 | 0.6 | 34.25 | 37.25 | 175.41 |
| Blank control | 15.5 | ≤5.5 | 0.6 | 19.54 | 27.31 | 67.12 |
| group | | | | | | |

It can be seen from Table 1 that the health cultivation wine prepared according to the method provided by the disclosure has better nutritional value and quality than Baijiu (blank control health cultivation wine).

TABLE 2
Comparison of health cultivation wine and Baijiu without Chinese medicinal materials (blank)

| Project | Transparency | Smell | Taste | Total score |
|---|---|---|---|---|
| Highest | 40 points | 20 points | 40 points | 100 |
| score | | | | points |
| Class I | | | | Over 90 |
| | | | | points |
| | Bright color, no | The aroma is rich, | The taste is delicate, | |
| | sediment after 2 | soft, and not | smooth, soft, without | |
| | years of storage. | pungent. | any unusual flavors, | |
| | | | and the aftertaste | |
| | | | is long-lasting. | |
| Class II | | | | Over 75 |
| | | | | points |
| | It is relatively | The aroma is too light | The taste is delicate | |
| | transparent at first, | or too strong, not | and smooth, with no | |
| | but within half a year | soft enough. | obvious odor at the | |
| | of storage, some | | beginning, but after | |
| | precipitates and | | aftertaste, there are | |
| | suspended substances | | bitter and other odors. | |
| | could be observed | | | |
| | in the bottle. | | | |
| Class III | | | | Over 60 |
| | | | | points |
| | The finished product is | Mixed with slight odor | Lack of proper flavor, | |
| | slightly cloudy before | and strange odor. | with peculiar odor. | |
| | storage or within a | | | |
| | month of storage. | | | |
| Class IV | | | | Below 50 |
| | | | | points |
| | Significant | The peculiar odor is too | The taste is rough, | |
| | precipitation can | strong, almost covering | with obvious peculiar | |
| | be observed before | up the fragrance of the | odor and strange | |
| | storage of the | wine, giving people an | taste. | |
| | finished product. | uncomfortable feeling. | | |
| Embodiment 1 | 30 | 16 | 47 | 93 |
| Embodiment 2 | 29 | 15 | 46 | 90 |
| Blank control | 24 | 12 | 40 | 76 |
| group | | | | |

It can be seen from Table 2 that the score of the health cultivation wine prepared according to the method provided by the disclosure is higher than that of the sorghum liquor (blank). The health cultivation wine provided by the disclosure has the effects of invigorating qi and blood circulation, beautifying and nourishing the skin, regulating the spleen and stomach, can improve human immunity after long-term administration, and has a good taste, meeting people's demand on the development of drinking in the direction of low-grade, health care, and functionalization.

The above are only the illustrated embodiments of the disclosure, and it should be pointed out that the above illustrated embodiments should not be regarded as the limitation of the disclosure, and the protective scope of the disclosure should be subject to the scope defined by the claims. Those skilled in the art may make several improvements and modifications without departing from the spirit and scope of the disclosure, and these improvements and modifications are also considered to be within the scope of the disclosure.

What is claimed is:

1. A health cultivation wine, comprising the following raw materials calculated by weight percentage:
90-99% Baijiu;
0.05-1% turtle shell;
0.05-1% shark cartilage;
0.5-1% garlic;
0.05-1% Panax quinquefolius;
0.75-1% Lycium chinense;
0.25-1% jujube;
0.75-1% Angelica sinensis; and
0.75-1% Rehmannia glutinosa;
wherein the Baijiu is sorghum liquor of 53-56 degrees.

2. A preparation method of the health cultivation wine as claimed in claim 1, comprising the following steps:
(1) soaking sorghum, steaming the soaked sorghum, re-steaming the steamed sorghum, then removing the re-steamed sorghum, and cooling the removed sorghum to 24-28 Celsius degree (° C.); sprinkling 1% yeast powder calculated by weight percentage in the cooled sorghum to stir evenly to obtain a mixture, performing solid-state culture on the mixture for 24 hours, and performing fermentation on the cultured mixture in a fermentation tank to obtain a fermentation product; taking out the fermentation product from the fermentation tank, and performing pyrogenic distillation on the taken fermentation product to obtain the sorghum liquor; wherein the sorghum liquor is stored in an earthen wine jar;
(2) washing the turtle shell, placing the washed turtle shell in a covered vessel, adding 10% water calculated by weight percentage into the covered vessel, and put the covered vessel added with the washed turtle shell and the water in a high-pressure cooker for 3-4 hours, and completely softening the turtle shell into a paste to obtain a turtle shell paste; drying the turtle shell paste and crushing the dried turtle shell paste to obtain turtle shell powder;
(3) peeling the garlic, sealing and keeping the peeled garlic away from light for 5-7 days at 3-5° C. until a bottom of the sealed garlic has a white beard in a range of 25-35 millimeters (mm) to obtain a target garlic, then taking out the target garlic and soaking the taken target garlic in mature vinegar, and finally taking out the soaked target garlic to dry and crush sequentially, to obtain garlic powder;
(4) drying the shark cartilage, crushing the dried shark cartilage to obtain shark cartilage powder, and then mixing the shark cartilage powder with the turtle shell powder obtained in the step (2) in proportion to obtain a first mixed intermediate, and placing the first mixed intermediate in an oven to bake the first mixed intermediate to obtain mixed powder;
(5) adding the garlic powder obtained in the step (3) into the mixed powder obtained in the step (4) in proportion to obtain a second mixed intermediate, placing the second mixed intermediate in a tank of a high-speed disperser and then stirring the second mixed intermediate with the sorghum liquor, to obtain a wine mixture;
(6) mixing the Panax quinquefolius, the Lycium chinense, the jujube, the Angelica sinensis, and the Rehmannia glutinosa in proportion to obtain a mixed traditional Chinese medicine;
(7) adding water into the mixed traditional Chinese medicine obtained in the step (6) to submerge a surface of the mixed traditional Chinese medicine for 1 centimeter (cm) to 2 cm, with a ratio of solid to liquid of 1:10, and then soaking the mixed traditional Chinese medicine in the water for 1 hour to obtain a soaked mixture; performing ultrasonic extraction on the soaked mixture under an ultrasonic frequency of 20 kilohertz (kHz) at a temperature in a range of 45° C.-50° C. to obtain an extracted product, filtering the extracted product to obtain medicine liquid, extracting the medicine liquid with water for three times continuously to obtain filtrates, mixing the filtrates, concentrating the mixed filtrates in vacuum to be a paste, and storing the paste for later use; and
(8) pouring the wine mixture obtained in the step (5) and the paste obtained the in the step (7) into an earthen wine jar for sealing to a mixed product, storing the mixed product at 10-15° C. for 170-190 days, and then filling the stored product to produce the health cultivation wine.

3. The preparation method as claimed in claim 2, wherein fermentation time of the fermentation in the step (1) is in a range of 10-15 days.

4. The preparation method as claimed in claim 2, wherein a temperature of the fermentation in the step (1) is in a range of 28-38° C.

5. The preparation method as claimed in claim 2, wherein a temperature of the fermentation in the step (1) is 28° C.

6. The preparation method as claimed in claim 2, wherein a temperature of the fermentation in the step (1) is in 38° C.

7. The preparation method as claimed in claim 2, wherein soaking days of the soaking in the step (3) are in a range of 55-65 days.

8. The preparation method as claimed in claim 2, wherein soaking days of the soaking in the step (3) are 55 days.

9. The preparation method as claimed in claim 2, wherein soaking days of the soaking in the step (3) are 65 days.

10. The preparation method as claimed in claim 2, wherein a baking temperature of the oven in the step (4) is in a range of 55-65° C.

11. The preparation method as claimed in claim 2, wherein a baking temperature of the oven in the step (4) is 55° C.

12. The preparation method as claimed in claim 2, wherein a baking temperature of the oven in the step (4) is 65° C.

13. The preparation method as claimed in claim 2, wherein time of the ultrasonic extraction in the step (7) is in a range of 20-30 minutes (min).

14. The preparation method as claimed in claim 2, wherein time of the ultrasonic extraction in the step (7) is 20 min.

15. The preparation method as claimed in claim 2, wherein time of the ultrasonic extraction in the step (7) is 30 min.

16. The preparation method as claimed in claim 2, wherein time of the stirring in the step (5) is in a range of 55-65 min.

17. The preparation method as claimed in claim 2, wherein time of the stirring in the step (5) is 55 min.

18. The preparation method as claimed in claim 2, wherein time of the stirring in the step (5) is 65 min.

19. A health cultivation wine, wherein the health cultivation wine is made from raw materials as follows:
1000 kilograms (kg) Baijiu;
0.5 kg turtle shell;
0.5 kg shark cartilage;
5 kg garlic;
0.5 kg Panax quinquefolius;
7.5 kg Lycium chinense;
2.5 kg jujube;
7.5 kg Angelica sinensis; and
7.5 kg Rehmannia glutinosa;
wherein the Baijiu is sorghum liquor of 53 degrees.

20. A preparation method of the health cultivation wine as claimed in claim 19, comprising the following steps:
(1) soaking sorghum, steaming the soaked sorghum, re-steaming the steamed sorghum, then removing the re-steamed sorghum, and cooling the removed sorghum to 24° C.; sprinkling 1% yeast powder calculated by weight percentage in the cooled sorghum to stir evenly to obtain a mixture, performing solid-state culture on the mixture for 24 hours, and performing fermentation on the cultured mixture in a fermentation tank at 28° C. for 15 days to obtain a fermentation product; taking out the fermentation product from the fermentation tank, and performing pyrogenic distillation on the taken fermentation product to obtain the sorghum liquor; wherein the sorghum liquor is stored in an earthen wine jar;
(2) washing the turtle shell, placing the washed turtle shell in a covered vessel, adding 10% water calculated by weight percentage into the covered vessel, and put the covered vessel added with the washed turtle shell and the water in a high-pressure cooker for 3 hours, and completely softening the turtle shell into a paste to obtain a turtle shell paste; drying the turtle shell paste and crushing the dried turtle shell paste to obtain turtle shell powder;
(3) peeling the garlic, sealing and keeping the peeled garlic away from light for 5 days at 5° C. until a bottom of the sealed garlic has a white beard in a range of 25 mm to obtain a target garlic, then taking out the target garlic and soaking the taken target garlic in mature vinegar for 55 days, and finally taking out the soaked target garlic to dry and crush sequentially, to obtain garlic powder;
(4) drying the shark cartilage, crushing the dried shark cartilage to obtain shark cartilage powder, and then mixing the shark cartilage powder with the turtle shell powder obtained in the step (2) in proportion to obtain a first mixed intermediate, and placing the first mixed intermediate in an oven to bake the first mixed intermediate at a bake temperature of 55° C. to obtain mixed powder;
(5) adding the garlic powder obtained in the step (3) into the mixed powder obtained in the step (4) in proportion to obtain a second mixed intermediate, placing the second mixed intermediate in a tank of a high-speed disperser and then stirring the second mixed intermediate with the sorghum liquor for 55 min, to obtain a wine mixture;
(6) mixing the Panax quinquefolius, the Lycium chinense, the jujube, the Angelica sinensis, and the Rehmannia glutinosa in proportion to obtain a mixed traditional Chinese medicine;
(7) adding water into the mixed traditional Chinese medicine obtained in the step (6) to submerge a surface of the mixed traditional Chinese medicine for 1 cm, with a ratio of solid to liquid of 1:10, and then soaking the mixed traditional Chinese medicine in the water for 1 hour to obtain a soaked mixture; performing ultrasonic extraction on the soaked mixture under an ultrasonic frequency of 20 kHz at a temperature of 45° C. for 20 min to obtain an extracted product, filtering the extracted product to obtain medicine liquid, extracting the medicine liquid with water for three times continuously to obtain filtrates, mixing the filtrates, concentrating the mixed filtrates in vacuum to be a paste, and storing the paste for later use; and
(8) pouring the wine mixture obtained in the step (5) and the paste obtained the in the step (7) into an earthen wine jar for sealing to a mixed product, storing the mixed product at 10° C. for 170 days, and then filling the stored product to produce the health cultivation wine.
